(19) United States
(12) Patent Application Publication
(10) Pub. No.: US 2003/0011625 A1
(43) Pub. Date: Jan. 16, 2003

(54) Brightness control of displays using exponential current source

(76) Inventor: James T. Kellis, Tustin, CA (US)

Correspondence Address: KNOBBE MARTENS OLSON & BEAR LLP, 2040 MAIN STREET, FOURTEENTH FLOOR, IRVINE, CA, 92614, US

(21) Appl. No.: 09/904,960

(22) Filed: Jul. 13, 2001

(51) Int. Cl. G09G 3/32

(52) U.S. Cl. 345/690

(57) ABSTRACT

An apparatus and method of controlling brightness of a display device by providing a brightness control current that is exponentially related to digital inputs, so as to maintain perceived uniformity in changes to the level of display brightness. One embodiment of the apparatus comprises at least one digital input, an attenuator which receives the digital input and a reference voltage, and which outputs an attenuated voltage based on the digital input; a voltage-to-current converting amplifier circuit converts the attenuated voltage to current; and a current mirror circuit connected to an LED array provides current to control the LED array, wherein the control current is substantially exponentially related to the at least one digital input. Another embodiment comprises an input trimming resistor network used to enhance the accuracy of the output current values by compensating for the circuit variances as additional current mirrors are added to the apparatus.

### BACKGROUND OF THE INVENTION

1. Field of the Invention

This invention relates generally to electronic circuits and, more particularly to electronic circuits used in electronic visual displays which use arrays of current-controlled light emitting sources.

2. Description of the Related Art

The brightness of current-controlled light emitting sources is substantially proportional to the currents flowing in them. Such devices may include, for example, light emitting diodes (LED) with the maximum brightness of a display being often established by a “reference current” which sets equal or proportional currents into a large number of light emitting sources. The visual pattern of the display then depends upon in which and for how long a time the current flows in the various light sources.

The nature of perceived brightness in human vision is that over a great range of illumination levels, equal ratios of light power, or luminance, are sensed as equal changes in relative brightness. For example, a 5-watt night-light being turned on in a darkened bathroom provides a significant brightness change while a 100-watt porch light being turned on in the daytime is hardly visible. Basically, one would have the same change-of-brightness sensation by turning on another 5-watt light in a room which was illuminated by a 5-watt light as turning on another 100-watt light in a room illuminated by a 100-watt light.

Portable displays may often be used over widely varying ranges of background illumination. Thus, the range of brightness control for portable displays will often need to be greater than the range of brightness control for displays such as a computer monitor that are not subject to widely varying ranges of background illumination.

Prior art circuit designs have generally provided for linear brightness outputs resulting from digital inputs. These designs do not address the non-linear relationship between the perceived brightness and the actual brightness. The perceived brightness refers to a physiological response to light whereas the actual brightness refers to luminance, a measurable intensity of light. Other prior art designs may use a non-linear/logarithmic potentiometer to control the display screen brightness. A problem with this arrangement is that it is not easily adapted to electronic and/or digital control and results in degraded accuracy of brightness control. Other attempts to address the non-linear relationship between the perceived brightness and the actual output current include electronic storage (“lookup table”) of appropriate digital values which transform brightness control steps to corresponding desirable output values. The problem with this approach is its unnecessary complexity and cost.

Thus, what is needed in the art is a convenient system and method for providing electric current output values in electronic display reflecting the non-linear relationship between the perceived brightness and the actual brightness of the display, thereby providing a uniformly-varying brightness control.

### SUMMARY OF THE INVENTION

The invention provides a uniformly-varying brightness control for a display wherein the ratio of light power is held constant for each increment of brightness control values. The ratio of light power is regulated via a digitally-controlled circuit which provides electric current output values that are exponentially related to digital input values. The number of digital inputs as well as the exponential factor of output currents may be arbitrarily chosen for implementation.

The invention comprises an apparatus for providing a uniformly-varying brightness control for a display screen, the apparatus comprising a plurality of digital inputs and a reference voltage, the digital inputs received by an attenuator connected to a plurality of voltage-to-current converting amplifier circuits, which in turn are connected to a plurality of current mirror circuits. The attenuator attenuates the reference voltage based on the value of the digital inputs. The attenuated voltage is received by the plurality of voltage-to-current amplifier circuits and converted to a current signal which is received by the plurality of current mirror circuits. A plurality of the current mirror circuits generates various ranges of currents to drive an LED array of a display screen.

The invention also comprises a method of providing output current that is exponentially related to digital inputs. The method comprises applying a reference input to an attenuator, attenuating the reference input, converting the attenuated voltage to current, and generating output current wherein the output current is exponentially related to the digital inputs.

One embodiment of the invention comprises using four digital input control lines as the digital input. Another embodiment of the invention comprises using five digital input control lines as the digital input. The number of lines in the digital input can be increased to improve the resolution and/or the range of the output current generated by an apparatus.

Another embodiment of the invention comprises an input trimming resistor network. The input trimming resistor network enhances the accuracy of the output current values by compensating for the effect of variances among additional circuit components as additional current mirrors are added to make up the total required number of current mirror circuits.

### BRIEF DESCRIPTION OF THE DRAWINGS

These and other features will now be described with reference to the drawings summarized below. These drawings and the associated description are provided to illustrate various embodiments of the invention, and not to limit the scope of the invention.

FIG. 1 is a block diagram illustrating the overall system according to one embodiment of the invention.

FIG. 2 is a graph 134 depicting the relationship between the digital input 120 and actual brightness of the system of FIG. 1 as measured by light power, P.

FIG. 3 is a graph depicting the relationship between the digital input signal 120 and the perceived brightness 142 of the system shown in FIG. 1.

FIG. 4 is a block diagram illustrating the details of the exponential brightness control circuit according to one embodiment of the invention.

FIG. 5 is a schematic diagram illustrating an example implementation of the exponential brightness control circuit of FIG. 4.

FIG. 6 illustrates the extended connections showing the connections to an LED array.

FIG. 7 is a schematic diagram illustrating an embodiment of the exponential brightness control circuit using five digital input control lines and an input trimming resistor network.

FIG. 8 is a flow chart illustrating one embodiment of the exponential brightness control circuit of the invention.

### DETAILED DESCRIPTION OF THE INVENTION

In the following description, reference is made to the accompanying drawings, which form a part hereof and which show, by way of illustration, specific embodiments or processes in which the invention may be practiced. Where possible, the same reference numbers are used throughout the drawings to refer to the same or like components. In some instances, numerous specific details are set forth in order to provide a thorough understanding of the invention. The invention, however, may be practiced without the specific details or with certain alternative equivalent devices or components and methods to those described herein. In other instances, well-known methods and devices or components have not been described in detail so as not to unnecessarily obscure aspects of the invention.

### Circuit Overview

The various embodiments provide digitally-controlled circuits which provide electric current output values that are exponentially related to digital input values. The number of digital inputs as well as the exponential factor of output currents may be arbitrarily chosen to suit the needs of a particular implementation of the circuit.

Generally, the digitally-controlled circuit comprises three basic elements: an exponential attenuator followed by one or more voltage-to-current converting amplifiers having selectable gain steps that are in turn connected to current mirrors. The amplifiers and current mirrors are scaled to provide optimum gain and current levels when they are selected by the appropriate digital input. The digitally-controlled circuit maintains the ratio of light powers constant for each increment of brightness control.

Although an exponential attenuator is included in the example embodiments of the digitally-controlled circuit, it is not required that the digitally-controlled circuit as disclosed herein includes an attenuator. The use of the exponential attenuator adds simplicity and accuracy to the digitally-controlled circuit.

Specific implementation of a digitally-controlled circuit comprising above basic elements is accomplished by selecting values of various factors. Values of various factors such as the number of bits in the digital input and the overall current range to be handled by the digitally-controlled circuit are selected to define other parameters of the digitally-controlled circuit. For example, the number of bits in the digital input, ‘b’, defines the number of discrete positions, N, in the brightness control device, i.e., N=2^{b}. For example, digital input comprising 3 bits will result in 2³ or 8 discrete positions in the brightness control device.

As stated previously, a uniformly-varying brightness control for a display is described wherein the ratio of light power is held constant for each increment of brightness control values to produce a uniform change in the perceived brightness. Various factors such as the number of bits in the digital input, ‘b’ which results in ‘N’ discrete positions, ratio of light power between adjacent positions, light power at each position, and total range of brightness control are discussed to illustrate the interrelationship among the factors. The interrelationship among the factors is considered to develop various embodiments of the digitally-controlled circuit. For instance,

Step Ratio of light power (“SR”)=P(n+1)/P(n),

where ‘P’ denotes the light power at the indicated position.

Thus,

P(1)=P(0)×SR

P(2)=P(1)×SR=P(0)×SR²

P(3)=P(0)×SR³

so that

P(n)=P(0)×SRⁿ, and

P(N−1)=P(0)×SR^{(N-1)} for the largest available value.

Thus, the total range of the control is from P(0) minimum to P(N−1) maximum, or

Range=P(N−1)/P(0)=SR^{(N-1)}

In other words, given that the basic requirement of the brightness control circuit is its range and the input is most likely a binary word, the step ratio of each increment of light power and the number of bits in the input binary word have a fixed relationship presuming that all of the binary bits in the digital input are used. For example, if the number of bits in the input binary word is selected to be 5 and the range is selected to be 100, then:

Number of Discrete position=N=2⁵=32

Number of Discrete steps=N=1=31

Step Ratio=Range^{1/(N-1)}=Range^{1/31}=1.16 i.e., 0.64 dB per step

Given that a binary-coded digital input comprises:

n=b₀×2⁰+b₁×2¹+b₂×2²+b₃×2³+. . . , where the coefficients bₙ, each denoting the bit number in the digital input, have values of only 0 or 1

Then,

P(n)=P(0)×[SR]exp(b₀×2⁰+b₁×2¹+b₂×2²+b₃×2³+. . . ).

Or, alternately,

P(n)=P(0)×[SR]exp(b₀×2⁰+b₁×2¹)×[SR]exp(b₂×2²+b₃×2³+. . . ).

This illustrates that a digitally-controlled circuit can comprise one or more stages wherein the stages may be cascaded. The stages may be cascaded whereby the output of one stage may be multiplied by a second to obtain the total output. It can be seen that the “steps” of the second stage are larger by some factor of 2 than the first stage, depending upon the number of bits applied to the first stage. Moreover, the second stage can be arranged so that two or more parts can be selectively connected to obtain all the values of the total.

As, when the second stage uses two bits,

[SR]exp(b₂×2²+b₃×2³)=[SR]exp(4×(b₂×2⁰+b₃×2¹))=[SR]exp(4×(b₂+b₃×2))

=[SR]exp(4×b₂) if b₂=0 or 1 and b₃=0 or,

=[SR]exp(4(b₂+2))=[SR]exp(8)×[SR]exp(4×b₂) if b₂=0 or 1 and b₃=1

It should be clear that there are a variety of possible ways to arrange the circuit to accommodate the required number of bits of control, accuracy and simplicity being the guide, not the arithmetic. It should also be apparent that greater the number of steps, the lower the progression of light power, i.e., finer the brightness control adjustment.

Within the above general guidelines, the specific design or implementation of the digitally-controlled circuit can have various configurations depending upon the specific display requirements of the application. The number of bits in the digital input and the overall current range thus define the specific characteristics of each of the three elements of the digitally-controlled circuit.

### Example Embodiments

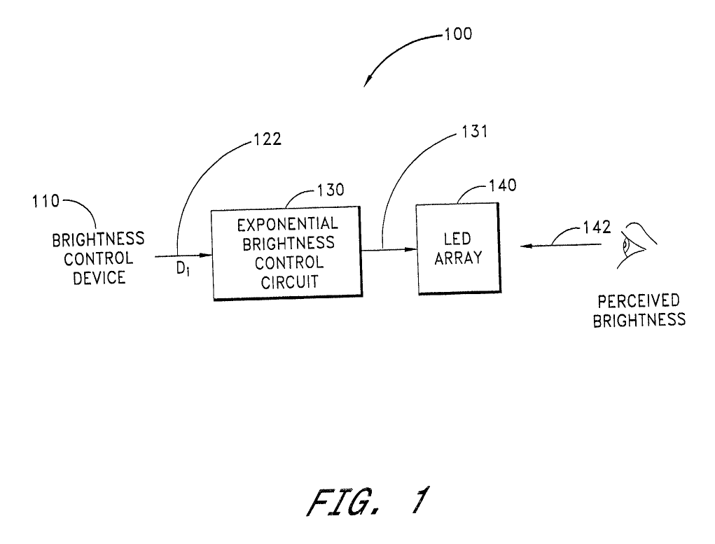

Example embodiments of the digitally-controlled circuit are now described. FIG. 1 illustrates a system 100 according to one embodiment of the invention. System 100 comprises a brightness control device 110 generating digital output Dᵢ connected via a line 122 to an exponential brightness control circuit 130. The brightness control device 110 generating the digital output Dᵢ could be a mechanical device or a purely electronic device. For example, the brightness control device 110 can be a mechanical knob. The brightness control device 110 can also be an automatic control circuit that generates the appropriate digital signal in response to automatic brightness sensor signals, for example. The digital output Dᵢ is connected via a line 122 to the input of an exponential brightness control circuit 130. The current output from the exponential brightness control circuit 130 are connected via line 131 to an LED array 140 and illuminates the LED array 140 of a display screen thereby creating a visual pattern on the display screen producing the perceived brightness 142. Line 131 comprises a plurality of lines connecting a plurality of output currents to the LED array 140.

As a user adjusts the brightness control device 110 for the display screen, an associated digital signal Dᵢ is generated. For example, as the user increases the manual brightness control device 110, the value of the digital signal Dᵢ is increased. The digital signal Dᵢ generated by the brightness control device 110 is received by an exponential brightness control circuit 130. The exponential brightness control circuit processes the digital signal Dᵢ so as to generate output current signal on line 131 which are exponentially related to the digital signal Dᵢ. The output current on line 131 comprises multiplicity of matched currents which are in turn received by the LED array 140 to drive the LED array generating a visual pattern on a display screen wherein the visual pattern is determined by the one or more illuminated LEDs. As mentioned previously, the line 131 comprises plurality of lines to the LED array.

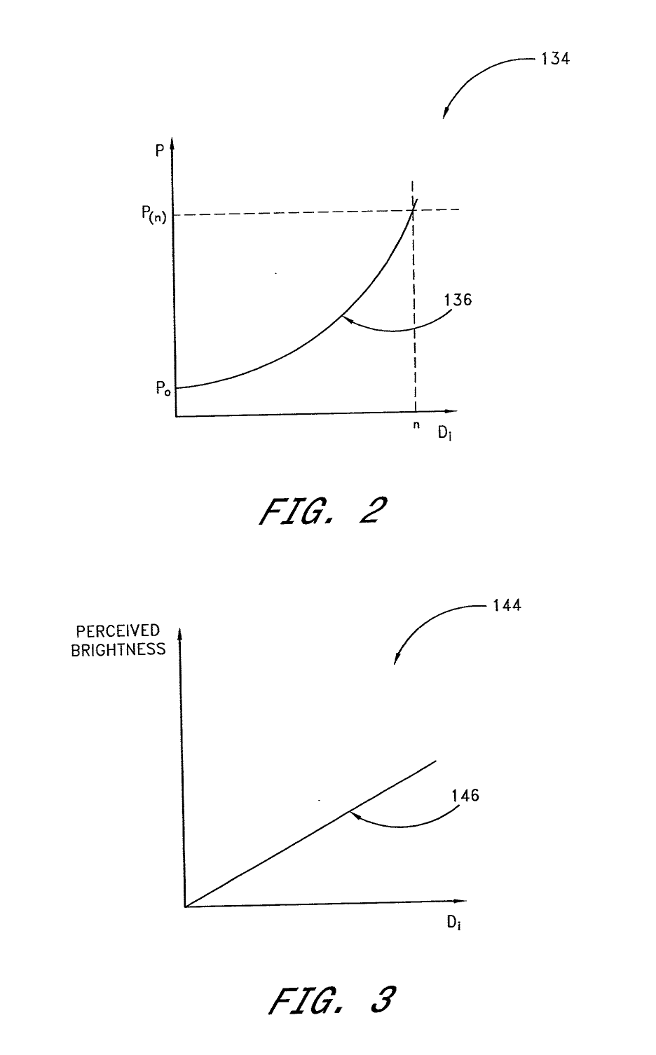

FIG. 2 is a graph 134 depicting the relationship between the digital signal Dᵢ and actual brightness of the system of FIG. 1 as measured by light power, P. As illustrated by line 136 on graph 134, as the digital signal Dᵢ increases, the magnitude of the light power generated by the exponential brightness control circuit 130 increases exponentially.

In contrast, FIG. 3 is a graph 144 depicting the relationship between the digital signal D₁ and the user perceived brightness 142 of the system shown in FIG. 1. As illustrated by line 146 on graph 144, as the magnitude of the digital input signal 120 increases, the brightness of the display screen perceived by the user increases linearly assuming same background illumination conditions. In other words, the user perceives a linear increase in brightness while the actual current output 132 is increasing exponentially.

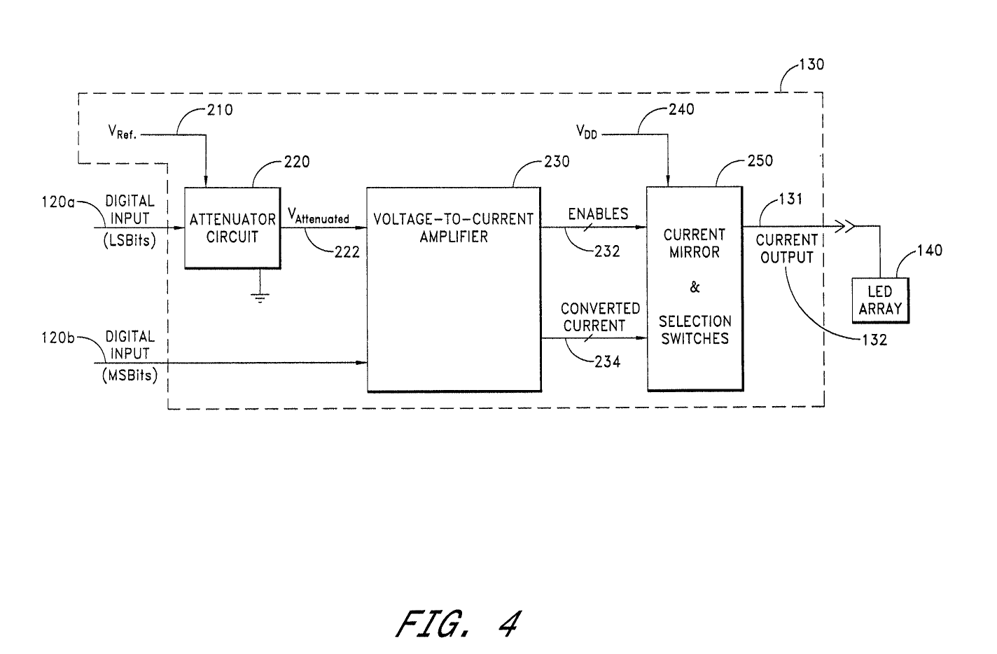

FIG. 4 is a block diagram illustrating the details of the exponential brightness control circuit 130 according to one embodiment of the invention. In this embodiment, the exponential brightness control circuit 130 receives the digital input signal shown as digital inputs 120a and 120b. Digital input signal 120a represents the least significant bits of the digital input control lines and is input to an attenuator circuit 220. The digital input signal 120b represents the most significant bits of the digital input control lines and is input to a voltage-to-current amplifier 230. Various embodiments can be implemented using different number of bits in the digital input.

An output line 222 of the attenuator circuit 220 is also connected to the voltage-to-current amplifier circuit 230. The voltage-to-current amplifier circuit 230 is connected via an enable line 232 and also via a converted current line 234 to a current mirror circuit 250. The current mirror circuit 250 generates one or more output currents that drive one or more columns of the LED array 140 of a display screen.

A typical LED array comprises a plurality of diodes which are configured to define a set of columns and a set of rows. The determination as to which diode in the array is be to illuminated is made by enabling both the row and the column that corresponds to the particular diode in the array. Each column of the LED array is tied to an output current generated by a current mirror and a particular row is selected by a switch which connects the row to a common terminal, providing a path for the current to flow. Since each column of the LED array is fed by a separate current source, the number of output currents to be generated by the current mirror circuit 250 is determined by the number of columns of a particular LED array that need to be driven.

Operation of the brightness control circuit 130 is now described referring to FIG. 4. FIG. 4 illustrates that a reference voltage V_{REF} 210 is applied to the attenuator circuit 220. The least significant bits (LSBs) of the digital input signal Dᵢ, as represented by the digital input signal 120a, are applied to the attenuator circuit 220 while the most significant bits (MSBs) of the digital input signal Dᵢ, as represented by the digital input signal 120b, are applied to the voltage-to-current amplifier circuit 230. The least significant bits of the digital inputs are applied to the attenuator circuit 220 to maximize the amount of voltage applied to the voltage-to-current amplifier circuit 230. The level of voltage applied to the voltage-to-current amplifier circuit 230 is maximized to reduce the effect of offset errors resulting from the amplifier circuit. Acceptable error level varies depending on the required system performance criteria. For example, an error level of one step value may be acceptable for some applications but not for others.

V_{REF} 210 is used to establish the base analog voltage that is attenuated by the attenuator circuit 220. In this embodiment, the attenuator circuit 220 attenuates the received reference V_{REF} 210 based on the value of the digital inputs and outputs an attenuated voltage V_{Attenuated} 222. The attenuated voltage V_{Attenuated} 222 is then received by the voltage-to-current amplifier circuit 230. Alternative embodiments of the invention can comprise a plurality of voltage-to-current amplifier circuits. The voltage-to-current amplifier circuit 230 with current feedback converts the V_{Attenuated} 222 voltage to a current which is fed to the converted current line 234. The voltage-to-current amplifier circuit 230 also outputs an enable signal on enable line 232. The enable line 232 is used to enable a current mirror in the current mirror circuit 250. In another embodiment, a plurality of enable lines 232 and a plurality of converted current lines 234 may carry output signals from the voltage-to-current amplifier circuit 230 to enable and drive one or more current mirrors in the current mirror circuit 250.

As noted previously, the current mirror circuit 250 may comprise one or more current mirrors which is selected and enabled via one or more enable lines 232. Each current mirror generates a multiplicity of similar output currents. The number of current mirrors utilized in the exponential brightness control circuit and the output current generated therefrom can vary depending on the needs of the specific application of the exponential brightness control circuit 130. Many current mirrors may be required to drive an LED array since there may be, for example, hundreds of columns of diodes in an LED array.

Still referring to FIG. 4, the main power source V_{DD} 240 is applied to the current mirror circuit 250. The current mirror circuit 250 also receives the enable line 232 and the converted current line 234 from the voltage-to-current amplifier circuit 230. The enable line 232 enables and switches among one or more current mirrors within the current mirror circuit 250. The enable line 232 selects the current mirrors that are properly scaled to operate over the portion of current range involved. In one embodiment where the current mirror circuit 250 comprises a plurality of current mirrors, only one current mirror is active at a time. The current mirror selected and enabled by the enable line 232 generates output current 132 which are placed on lines 131. The output current on lines 131 and can drive one or more column of the LED array 140.

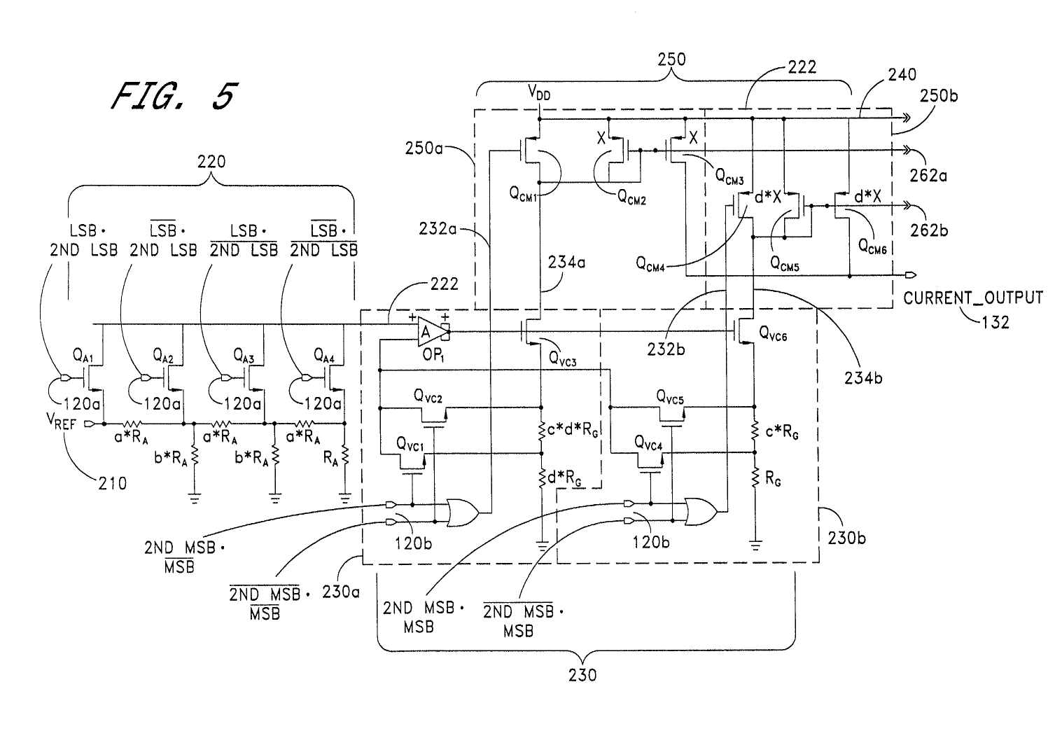

FIG. 5 is a schematic diagram illustrating an example implementation of the embodiment depicted in FIG. 4. In this example implementation which accommodates four binary bits, the attenuator circuit 220 comprises digital inputs 120a, reference voltage V_{REF} 210, transistors Q_{A1}, Q_{A2}, Q_{A3}, Q_{A4}, and various resistors. Digital inputs 120a comprise LSB of the digital signal Dᵢ logically ANDed with the 2^{nd} LSB of D₁.

In the embodiment illustrated in FIG. 5, the voltage-to-current amplifier circuit 230 comprises two stages, 230a and 230b. Stage 230a comprises digital inputs 120b, attenuated voltage V_{Attenuated} 222, an operational amplifier OP₁, transistors Q_{VC1}, Q_{VC2}, QVC₁₃ and two resistors, each representing some multiple value of a base resistor R_{G}. Likewise, stage 230b comprises digital inputs 120b, transistors Q_{VC4}, Q_{VC5}, Q_{VC6} and two resistors, each representing some multiple value of a base resistor R_{G}. Digital inputs 120b comprise MSB of the digital signal D₁ logically ANDed with the 2^{nd} MSB of Dᵢ. Operational amplifier OP₁ is common to both stages of the voltage-to-current amplifier circuit 230. The base resistor R_{G} and the various multiple values thereof determine the gain of the voltage-to-current conversion as the transistors Q_{VC1}, Q_{VC2}, Q_{VC4} and Q_{VC5} connect them to operational amplifier OP₁ feedback input.

Still referring to FIG. 5, the current mirror circuit 250 also comprises two stages, each stage designated, respectively, as 250a and 250b. Stage 250a comprises enable line 232a, transistors Q_{CM1}, Q_{CM2}, Q_{CM3}, and converted current line 234a. Likewise, stage 250b comprises enable line 232b, transistors Q_{CM4}, Q_{CM5}Q_{CM6}, and converted current line 234b. FIG. 5 also illustrates plurality of output current referenced as 262a and 262b.

The following equations govern the various relationships in the exponential brightness control circuit 130 of the example embodiment illustrated in FIG. 5. The variables a, b, c, and d are coefficients for resistor values in the circuit whereas the resistor R_{G} is used to control the range of the current handled by a particular current mirror stage. The values of these variables are determined by the various circuit parameters selected to create an instance of the exponential control circuit. In other words, the following equations are solved to create an instance of the exponential brightness control circuit using selected circuit parameters. As noted previously, various versions of the exponential brightness control circuit exhibiting output current exponentially related to the digital inputs as illustrated by the graph 134 in FIG. 2 can be created by selecting and using different circuit parameter values.

As illustrated by the following equations, the value of the resistor coefficients a, b, c, and d are determined as a function of various circuit parameters. These parameters include “StepRatio”, “V_{REF”}, “NoOfAttenStates”, and “NoOfStatesInV-to-I-Stage.” The values of these parameters are selected to design a particular exponential current source.

“StepRatio” refers to the ratio of light power between each increment of brightness change which is desired to remain constant. This is by design so all incremental changes in brightness will appear to be approximately equal to the eye. Each binary count of the digital input increases the output current by a factor of “Step Ratio”.

“NoOfAttenStates” refers to the number of possible states in the attenuator section.

“NoOfStatesInV-to-I-Stage” refers to the number of possible states in a voltage-to-current amplifier stage.

Similarly, the value of R_{G} is determined as a function of circuit parameters “V_{REF}” and “DesiredFullScaleCurrentOutput.” “V_{REF}” refers to the reference voltage 210, and “DesiredFullScaleCurrentOutput” refers to the desired full-scale current output desired to drive the LED array 140. For example, some example values of the desired output current to drive the LED array 140 may be 2 mA, “V_{REF}” may be 5V, and R_{G} may be 2500 Ω. These parameters are selected to determine the value of the resistor R_{G} and to thereby control the range of the current to be handled by a particular current mirror stage. The following equations describe the various parameters of the particular embodiment illustrated in FIG. 5 and are derived by performing circuit analysis. These parameters are selected to create a particular version of the exponential brightness control circuit exhibiting the exponential relationship between the digital inputs 120 and the actual brightness as measured by light power as illustrated by the graph 134 in FIG. 2. It should be obvious to one ordinarily skilled in the art that a different embodiment would result in different equations resulting from analysis of a different circuit.

Let a=StepRatio−1

$$b = \frac{1}{a} + 1$$

c=(StepRatio)^{(NoOfAttenStates)}−1

d=(StepRatio)^{(NoOfAttenstates)(NoOfState sin V-to-IStage)}

$${R}_{G} = \frac{{V}_{REF}}{( DesiredFullScaleCurrentOutput )}$$

Referring further to FIG. 5, the current mirror circuit 250 comprises two stages, 250a and 250b. Main power supply V_{DD} 240 provides power. Stage 250a comprises enable line 232a, converted current line 234a, and transistors Q_{CM1}, Q_{CM2}, and Q_{CM3}. Likewise, stage 250b comprises enable line 232b, converted current line 234b, and transistors Q_{CM4}, Q_{CM5}, and Q_{CM6}.

Regardless of the number of current mirror stages, only one stage is ‘on’ at any given moment where each current mirror stage is used to handle different ranges of current. The range of the current to be handled by each current mirror stage is determined by the resistors c*d*R_{G}, d*R_{G}, c*R_{G}, and R_{G} in the corresponding voltage-to-current stage. Each successive current mirror stage handles the major steps in the output current (e.g., 6 db, 12 dB, 24 dB, etc.) Each stage is designed to be accurate in the current region for which it is designed.

The LSB and the 2^{nd} LSB of the digital inputs, i.e., the digital input lines 120a, controls the attenuation of V_{REF}. and thereby the magnitude of the attenuated voltage V_{Attenuated} on line 222. Furthermore, the 2^{nd} MSB controls the gain of the Op Amp OP₁ while MSB controls which voltage-to-current stage is active. The attenuated voltage V_{Attenuated} is input to the OP₁ and the output from the OP1 feeds the gate of a transistor, either Q_{VC3} or Q_{VC6}, in the enabled voltage-to-current stage. Therefore, whichever transistor that is “on”, either Q_{VC3} or Q_{VC6}, regulates the current value in the enabled current mirror stage.

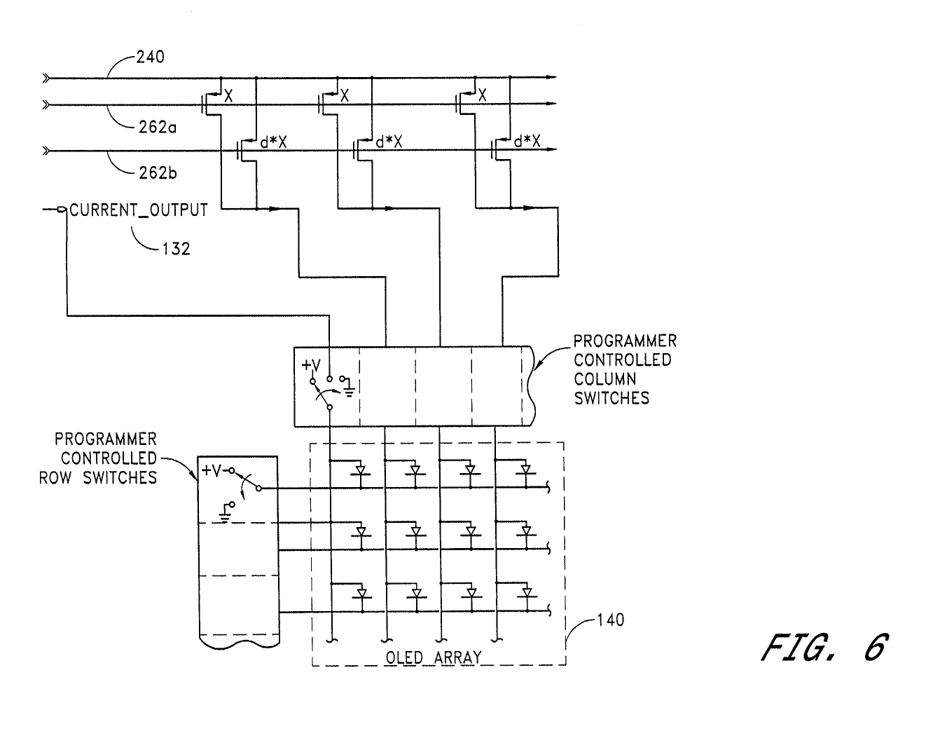

As noted previously, current mirror can be replicated to produce plurality of output currents. FIG. 6 illustrates the extended connections showing the connections of plurality of current outputs to an LED array.

Because the LEDs are physically very close together in a display, the output current generated by the adjacent current mirrors driving closely located LEDs should match closely. The extent of the match required among the adjacent current mirrors would be defined by the need of the display. For example, the currents generated by the adjacent current mirrors may need to match within 2% for some displays while other display can sustain a lower match percentage. Ability to match current can be improved by limiting the current range that a particular transistor in the current mirror carries and by sizing the transistor accordingly. Ability to match current can also be improved by addition of matched degeneration resistors in the transistor source terminal connections since resistor performance characteristics are more uniform than the transistors.

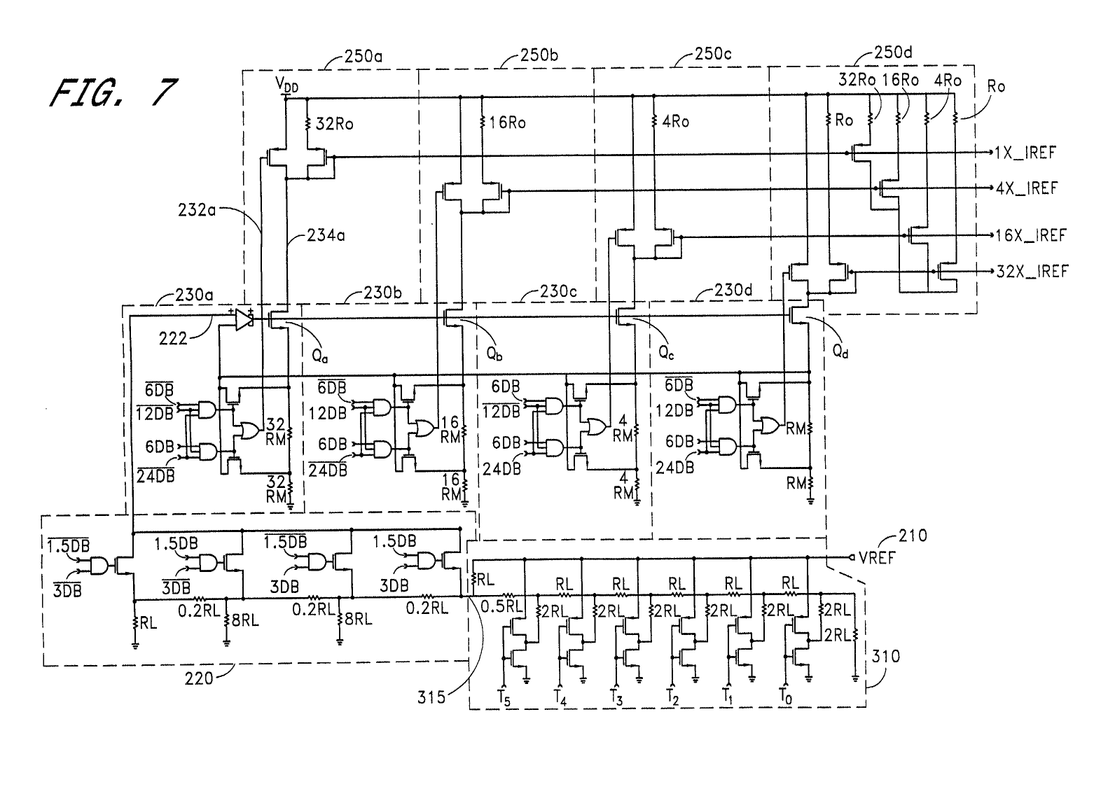

FIG. 7 illustrates another embodiment of the exponential brightness control circuit 130 using five digital input control lines as digital input signal. The dashed line block 220 represents the attenuator circuit, the dashed line 230 represents the voltage-to-current amplifier circuit, and the dashed line block 250 represents the current mirror. The voltage-to-current amplifier circuit 230 further comprises four voltage-to-current stages as represented by dashed blocks 230a, 230b, 230c, and 230d. Likewise, the current mirror circuit 250 comprises four current mirror stages as represented by dashed blocks 250a, 250b, 250c, and 250d. FIG. 7 also illustrates various resistors R0, RM, RL, and various multiple values of each e.g. 32RO, 16RO, 4RO.

The embodiment illustrated in FIG. 7 also comprises an input trimming resistor network 310. The input trimming resistor network 310 is used to adjust the absolute output current values with respect to the input reference voltage, V_{REF} 210. Should a display LED array be so large as to require more extended current output than can be provided by a single physical part such as a single integrated chip or a printed wiring board, for example, multiple current source parts can be employed. The input trimming resistor network 310 can be used to adjust the output currents to a common value to provide uniform display brightness. Additionally, input trimming resistor network 310 enables different voltage attenuation by changing the characteristics of the input trimming resistor network. A characteristic of the input trimming resistor network is changed based on the value of the digital inputs to the input trimming resistor network. In this embodiment, digital input lines T0, T1, T2, T3, T4, and T5 to the input trimming resistor network are decoded to trim the input reference voltage V_{REF} as a function of the binary value of the T digital inputs. In other words, T digital input lines are used to vary the net resistance of the input trimming resistor network 310 to control the attenuation of V_{REF} 210. Therefore, the values V_{REF} 210 and the node voltage 315 would be equivalent if the input trimming resistor network 310 were not employed.

The embodiment illustrated in FIG. 7 has more control positions which may be used to achieve a finer resolution and/or greater range than the embodiment illustrated in FIG. 6. The embodiment illustrated in FIG. 7 has a 5-bit control word to provide step ratios of 1.19 to 1 (1.5 dB current steps) for an overall range of approximately 211 to 1 (46.5 dB). The digital input lines to the voltage-to-current amplifier 230 in FIG. 7 are labeled as various step ratios. The labels 24 dB, 12 dB, 6 dB indicate the step ratio change that will result upon activation of the particular digital input line. This labeling is used indicate the effect of a digital “1” on the line particular line. For example, a digital “1” on the particular line will produce an output current that corresponds to the label. Since the output current is exponentially related to the digital inputs, the values in the labels are additive. For example, enabling the 24 dB line and the 6 dB line will produce an overall 30 dB output.

Each of the voltage-to-current stages 230a, 230b, 230c, and 230d provides two output lines and thereby provides two inputs to the current mirror circuit 250. One output, for example, the enable line 232a enables a corresponding current mirror stage 250a while the other output, for example, the converted current line 234a, provides the current input to the current mirror stage 250a.

In each of the voltage-to-current stages, a transistor is used in an analog manner to control the current flow to the current mirror. Transistor Qₐ is associated with stage a, transistor Q_{b} is associated with stage b, transistor Q_{c} is associated with stage c, and transistor Q_{d} is associated with stage d. The attenuated voltage V_{Attenuated} 222 is used to control the current flow in the appropriate analog transistor i.e., Qₐ, Q_{b}, Q_{c}, or Q_{d}.

Although various embodiments are illustrated using discrete components, any aspects of the exponential brightness control circuit 130, as well as the exponential brightness control circuit 130 itself, can be implemented in an integrated form including monolithic integration where precise component size and value ratios can be easily obtained.

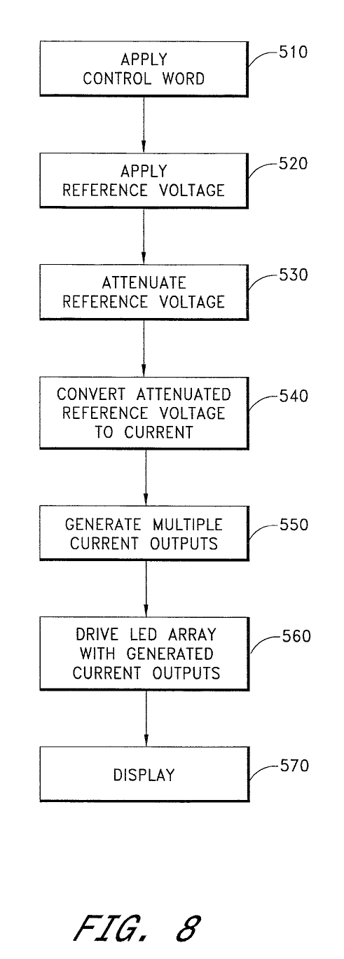

FIG. 8 is a flow chart illustrating operation of one embodiment of the exponential brightness control circuit 130. At a step 510, digital inputs are applied to the exponential brightness control circuit 130. The digital inputs can comprise any number of bits, each bit representing either a ‘1’ or a ‘0’ digital value. In one embodiment, the digital inputs comprise four bits. In another embodiment, the digital inputs comprise five bits.

At a step 520, a reference voltage is applied to the exponential brightness control circuit 130. The applied reference voltage is attenuated at a step 530 by an attenuator circuit 220.

At a step 540, the attenuated voltage is converted to a current by a voltage-to-current amplifier circuit 230. The voltage-to-current amplifier circuit can output signals onto a plurality of enable lines 232 and a plurality of converted current lines 234.

At a step 550, the converted current line 234 is used to communicate one or more output currents which, at step 560, are used to drive the LED array 140 of the display screen. At a step 570, the user views the display screen as highlighted by the output current flowing through the particular LEDs.

Although the invention has been described in terms of certain preferred embodiments, other embodiments that will be apparent to those of ordinary skill in the art, including embodiments which do not provide all of the features and advantages set forth herein, are also within the scope of this invention. Accordingly, the scope of the invention is defined by the claims that follow. In the claims, a portion shall include greater than none and up to the whole of a thing; encryption of a thing shall include encryption of a portion of the thing. In method claims, reference characters are used for convenience of description only, and do not indicate a particular order for performing a method.

What is claimed is:

1. An electronic brightness control circuit for a display wherein the display brightness changes uniformly to the cognizance of a user as the user adjusts the display brightness.

2. An apparatus which provides a uniformly-varying brightness control for a display screen, comprising:
a brightness control device;
a digital input representative of a state of the brightness control device; and
an exponential brightness control circuit responsive to the digital input for providing an output current to the display screen, so as to control brightness of said display screen, wherein the output current is exponentially related to the digital input.

3. An apparatus as defined in claim 2, wherein the digital input further comprises a plurality of digital inputs.

4. An apparatus as defined in claim 2, wherein the output current further comprises a plurality of output currents.

5. An apparatus which provides a uniformly-varying brightness control for a display screen, comprising:
a digital input;
an attenuator which receives the digital input and a reference voltage and provides an attenuated voltage output based on the digital input;
a voltage-to-current converting amplifier circuit which converts the attenuated voltage to current in response to the digital input; and
a current mirror circuit connected to an LED array so as to provide current to the LED array that is exponentially related to the digital input.

6. An apparatus as defined in claim 5, wherein the digital input further comprises a plurality of digital inputs.

7. An apparatus as defined in claim 6, wherein the current mirror circuit comprises a plurality of current mirror circuits, each of said plurality of circuits connected to the LED array so as to provide current that is exponentially related to at least one of the plurality of digital inputs to a respective portion of the LED array.

8. An apparatus as defined in claim 5, further comprising an input trimming resistor network.

9. A method of providing a uniformly-varying brightness control for a display screen, the method comprising:
applying a reference voltage and a digital input to a circuit;
attenuating the reference voltage based on the digital input;
converting the attenuated voltage to a converted current; and
providing an output current for controlling brightness of the display screen, said output current being related to the converted current and exponentially related to the digital input.

10. A method as defined in claim 9, wherein the digital input further comprises a plurality of digital inputs.

11. A control apparatus comprising means for controlling brightness of a display screen device wherein the controlling means provides current to said display screen device, said current having a magnitude that is substantially exponentially related to digital input to said display screen device.

12. A brightness control device for a display screen wherein, in response to a brightness control signal, the brightness control device produces a display control signal which compensates for a difference between a perceived display screen brightness and an actual display screen brightness.

13. A brightness control device as defined in claim 12, wherein the brightness control device is implemented using discrete components.

14. A brightness control device as defined in claim 12, wherein the brightness control device is implemented using monolithic integration.

15. An apparatus which provides a uniformly-varying brightness control for a display screen, comprising:
means for applying a reference voltage to a circuit;
means for applying a digital input to a circuit;
means for attenuating the reference voltage based on the digital input;
means for converting the attenuated voltage to current; and
means for providing at least one output current for controlling brightness of the display screen, in response to the digital input, wherein the at least one output current is exponentially related to the digital input.

16. An apparatus as defined in claim 15, wherein the means for providing at least one output current comprises means for providing a plurality of output currents.

17. An apparatus as defined in claim 16, wherein the means for applying a digital input comprises means for applying a plurality of digital inputs to the circuit.

18. An apparatus as defined in claim 17, wherein each of at least two of the plurality of digital inputs is related to a different one of at least two of the plurality of output currents.

19. An apparatus as defined in claim 18, wherein each of the at least two of the plurality of output currents defines a control signal which controls brightness of a different portion of the display screen.
